(19) United States
(12) Patent Application Publication
(10) Pub. No.: US 2003/0177872 A1
(43) Pub. Date: Sep. 25, 2003

(54) Ratchet tool having a flat pawl switch member

(76) Inventors: Tseng Shu-Ying, Taichung City (TW); Yu Hua-Rung, Taipei City (TW)

Correspondence Address: CHARLES E. BAXLEY, ESQUIRE, Hart, Baxley, Daniels & Holton, 59 John St, 5 Fl,, New York, NY, 10038, US

(21) Appl. No.: 10/104,529

(22) Filed: Mar. 25, 2002

(51) Int. Cl. B25B 13/46

(52) U.S. Cl. 81/63.2

(57) ABSTRACT

A ratchet tool includes a head with a toothed engaging member and a pawl respectively received therein. A top cap is engaged with the a step surface in the head. A pawl is received in a first recess defined in an inner periphery of the hole and engaged with the toothed outer surface of the engaging member. A pawl switch member is received in a rear section of the second recess and engaged with the pawl. A top surface of the pawl is flush with top the cap.

### FIELD OF THE INVENTION

The present invention relates to a ratchet tool that has a pawl switch member located in a recess of the head so that no convex portion extends from the surface of the head of the tool.

### BACKGROUND OF THE INVENTION

A conventional ratchet tool generally includes a head with a ratchet mechanism received therein and a handle connected to the head. The ratchet mechanism includes a toothed engaging member and a pawl is engaged with the teeth of the toothed engaging member. The pawl is controlled by a pawl shifting member which generally extends from the top surface of the head and the pawl shifting member limits the head of the tool from inserting into a recess to reach a bolt or an object to be tightened or loosened.

### SUMMARY OF THE INVENTION

In accordance with one aspect of the present invention, there is provided a ratchet tool which comprises a handle and a head which has a step surface with a hole defined therein so that a toothed engaging member is received in the hole. A first recess is defined in an inner periphery of the hole so as to receive a pawl therein which is engaged with the engaging member. A second recess is defined in the top surface of the head and communicates with the first recess.

A top cap is positioned on the step surface and a chamber is defined in an inner periphery of the first recess so as to receive a spring and a bead therein which contacts the pawl. A pawl switch member is received in a rear section of the second recess and engaged with the pawl. A top surface of the pawl is flush with top the cap.

The primary object of the present invention is to provide a ratchet tool wherein the pawl switch member is flush with the top cap of the head of the tool so that the thickness of the head is slim.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the ratchet tool of the present invention;

FIG. 2 is a top view to show the arrangement of the engaging member, the pawl and the pawl switch member of the ratchet tool of the present invention;

FIG. 3 is a cross sectional view to show the arrangement as shown in FIG. 2;

FIG. 4 is a top view to show that the pawl switch member is rotated counter clockwise;

FIG. 5 is a top view to show that the pawl switch member is rotated clockwise, and

FIG. 6 is an exploded view to show another embodiment of the ratchet tool of the present invention.

### DETAILED DESCRIPTION OF THE PREFERRED EMBODIMENTS

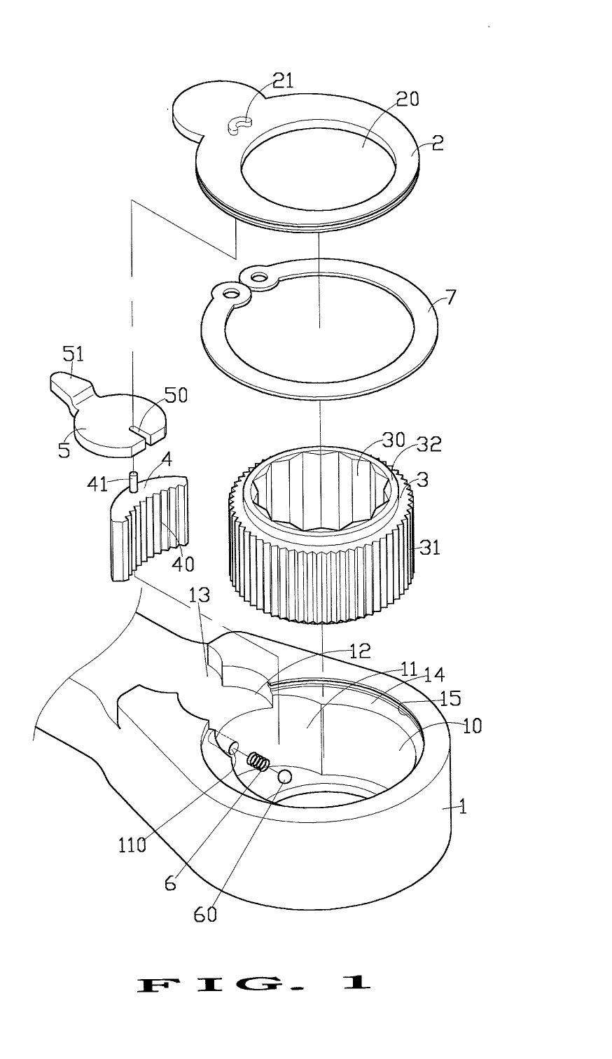

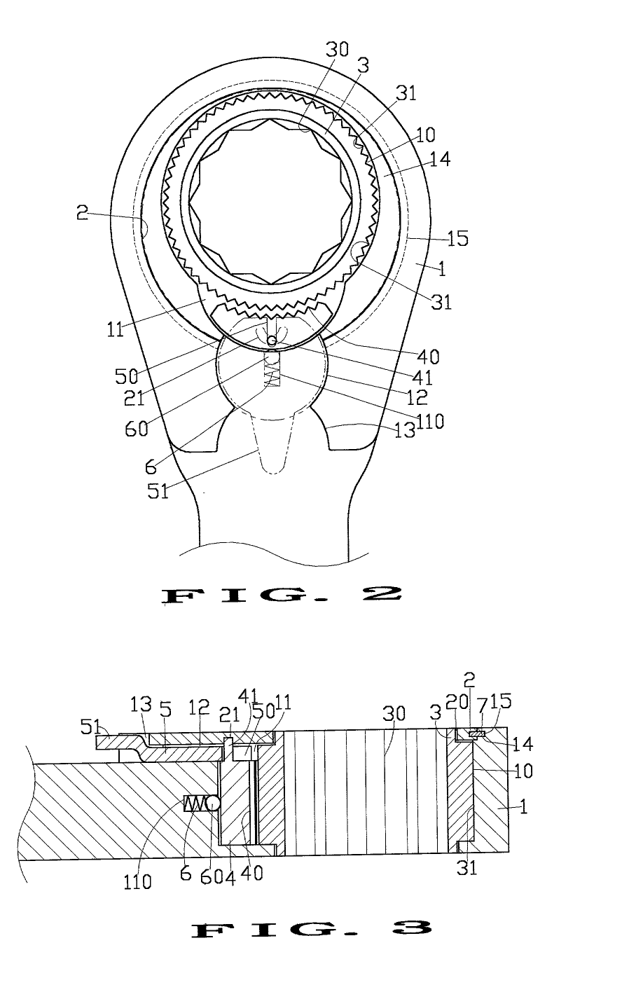

Referring to FIGS. 1 to 3, the ratchet tool of the present invention comprises a handle and a head 1 which has a concave step surface 14 and a hole 10 is defined in the step surface 14. An engaging groove 15 is defined in an inner periphery of the head 1 for receiving a C-shaped clamp 7 therein. A top cap 2 is positioned on the step surface 14 and has a groove 22 so that the C-shaped clamp 7 is engaged with the two respective grooves 15 and 22 to position the top cap 2. A hole 20 is defined through the top cap 2.

A first recess 11 is defined in an inner periphery of the hole 10 and a second recess 12 is defined in the top surface of the head 1 and communicates with the first recess 11. A chamber 110 is defined in an inner periphery of the first recess 11 and a spring 6 is received in the chamber 110 and a bead 60 is biased by the spring 6 and received in the chamber 110.

An engaging member 3 received in hole 10 of the head 1 and has a neck portion 32 which is engaged with the hole 20 of the top cap 2. The engaging member 3 has a toothed front surface 31 and the bead 60 contacts a back of the pawl 4.

A pawl 4 IS received in the first recess 11 and has a toothed surface 40 which is engaged with the toothed outer surface 31 of the engaging member 3. The pawl 4 has a protrusion 41 extending from a top thereof. A flat pawl switch member 5 is received in a rear section 13 of the second recess 12 and includes a notch 50 which receives the protrusion 41. A groove 21 is defined in an underside of the top cap 2 and the protrusion 41 of the pawl 4 is movably received in the groove 21. A handle portion 51 extends from the pawl switch member 5 and a top surface of the pawl 4 is flush with top the cap 2.

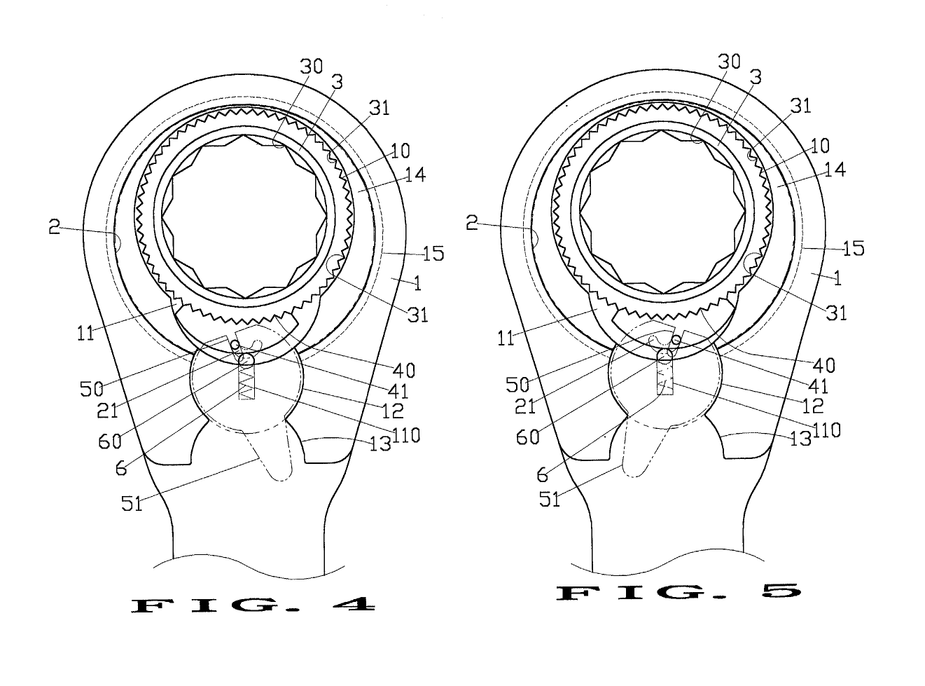

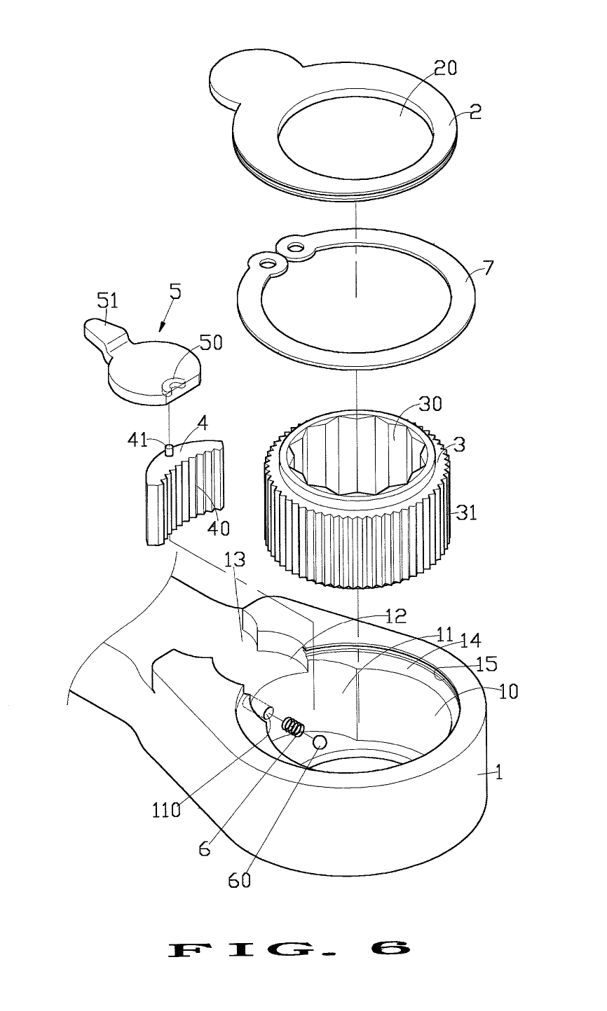

Referring to FIG. 4, when shifting the handle portion 51 of the pawl shifting member 5 counter clockwise, the pawl 4 is shifted by the pawl shifting member 5 and is stopped by the left inside of the first recess 11. The tool outputs an torque when rotating the handle of the tool counter clockwise. FIG. 5 shows that when the handle portion 51 of the pawl shifting member 5 is rotated clockwise, the pawl 4 is shifted by the pawl shifting member 5 and is stopped by the right inside of the first recess 11. The tool outputs an torque when rotating the handle of the tool clockwise.

FIG. 6 shows another embodiment that the protrusion 41 on the top of the pawl 4 is movably engaged with a groove 50 defined in an underside of the pawl switch member 5.

While we have shown and described the embodiment in accordance with the present invention, it should be clear to those skilled in the art that further embodiments may be made without departing from the scope of the present invention.

What is claimed is:

1. A ratchet tool comprising:
a handle and a head which has a concave step surface and a hole defined in the step surface, a first recess defined in an inner periphery of the hole, a second recess defined in the top surface of the head and communicating with the first recess;
a top cap positioned on the step surface and having a hole defined therethrough;
a chamber defined in an inner periphery of the first recess and a spring received in the chamber and a bead biased by the spring and received in the chamber;
an engaging member received in hole of the head and having a toothed front surface, the bead contacting a back of the pawl;
a pawl received in the first recess and having a toothed surface which is engaged with the toothed outer surface of the engaging member, and
a pawl switch member received in a rear section of the second recess and engaged with the pawl, a top surface of the pawl being flush with top the cap.

2. The ratchet tool as claimed in claim 1, wherein the pawl has a protrusion extending from a top thereof and the pawl switch member has a notch which receives the protrusion, a groove defined in an underside of the top cap and the protrusion of the pawl being movably received in the groove.

3. The ratchet tool as claimed in claim 1, wherein the pawl has a protrusion extending from a top thereof and the pawl switch member has a groove defined in an underside thereof, the protrusion of the pawl being movably received in the groove.
